(19) United States
(12) Patent Application Publication
(10) Pub. No.: US 2025/0100491 A1
(43) Pub. Date: Mar. 27, 2025

(54) CASTED COMPONENT FOR USE IN A PART OF A VEHICLE

(71) Applicant: Volvo Car Corporation, Goteborg (SE)

(72) Inventors: Per Nordenström, Goteborg (SE); Freddy Klint, Goteborg (SE)

(73) Assignee: Volvo Car Corporation, Goteborg (SE)

(21) Appl. No.: 18/890,818

(22) Filed: Sep. 20, 2024

(30) Foreign Application Priority Data
Sep. 27, 2023 (EP) 23199935.0

(51) Int. Cl. B60R 16/04; B62D 65/00

(52) U.S. Cl. CPC B60R 16/04; B62D 65/00

(57) ABSTRACT

The disclosure relates to a component for use in a part of a vehicle. The component comprising a guiding section configured for guiding the component relative to a sleeve when positioning the component inside the part of the vehicle, the guiding section comprising at least one guiding structure provided at a guiding side of the component, the at least one guiding structure comprising a groove extending at the guiding side and at least one protrusion directly adjacent to the groove and protruding away from the groove, the groove and the protrusion are extending substantially in parallel to each other along at least a portion of the guiding side.

### CROSS-REFERENCE TO RELATED APPLICATIONS

This application claims the benefit of European Patent Application Number 23199935.0, filed on Sep. 27, 2023, which is hereby incorporated by reference in its entirety.

### TECHNICAL FIELD

The present disclosure relates to a casted component for use in a part of a vehicle, a set of such a component and a sleeve, a part of a vehicle and a vehicle.

### BACKGROUND

In the assembly of vehicle parts, such as battery packs, a guiding system is required that makes sure that components of the part are assembled correctly with one another. Further, the guiding system needs to enable the assembly of the respective components in a way that they stay in place when assembled.

Such guiding systems often use holes and pins in the components respectively assembled with one another. This solution brings high cost and complexity to the assembly as it requires designing the components with the holes and pins.

Further, for some vehicle parts, there may be special requirements, e.g., they may benefit from or even require a fluid tight structure, which may be the case with batteries, for example. Introducing holes in components of such vehicle parts to guide the components thereof upon assembly increases the risk of leakage, which may be a critical problem when it comes to the safety of the vehicle and the lifetime of the battery.

### SUMMARY

The above disadvantages are at least partially relieved by the subject matter of the independent claims of the present disclosure, wherein further examples are incorporated in the dependent claims.

According to a first aspect of this disclosure, there is provided a component comprising: a guiding section configured to guide the component relative to a sleeve when positioning the component inside a part of a vehicle. The guiding section comprises at least one guiding structure located on a guiding side of the component. The at least one guiding structure comprises a groove extending at the guiding side and at least one protrusion directly adjacent to the groove and protruding away from the groove. The groove and the at least one protrusion are extending substantially in parallel to each other along at least a portion of the guiding side.

The component is accordingly provided with a guiding capability that is leakage-proof as no holes and/or pins need to be introduced in the component. The component may be guided via its guiding section relative to the sleeve, which may be a further component for use in the part of the vehicle, when positioning the component inside the part of the vehicle. The at least one guiding structure, having the round groove and protrusion, provides for the guiding of the component. Specifically, by having the groove adjacent to the protrusion, the tolerances of the guiding section may be kept very tight, in particular a tolerance between the at least one protrusion and the sleeve, and specifically when the component is a casted component as discussed below.

In the sense of this disclosure, positioning relates to the task of positioning the component relative to the sleeve. Guiding relates to a subtask of the positioning process, assisting the positioning by means of the configuration of the guiding section relative to the sleeve such that the positioning is facilitated. Positioning does not include fixing or attaching the component and/or the sleeve to each other and/or other elements of the part, which may be a further step, in particular after the positioning has been carried out successfully.

The component may be a casted component. This has the advantage of low manufacturing costs for the component. However, typically, casting the component requires a radius between the guiding side and the protrusion. This, however, may increase the clearance, specifically between protrusions of opposing guiding structures, and thereby create greater tolerances for guiding the component relative to the sleeve than desirable, which may result in a poor guiding. Providing the groove at the time of casting of the component removes the need for additional manufacturing steps, such as machining the groove into the component, to achieve tighter tolerances. Such additional manufacturing steps would otherwise add further costs to the manufacturing process of the casted component. For manufacturing the casted component, liquid material may be poured into a mold, which may contain a hollow cavity of a desired shape of the component, and then allowed to solidify. The solidified component may consequently be ejected or broken out of the mold to complete the process and obtain the casted component. The material of the component may comprise or be a metal, e.g., steel or aluminum.

The protrusion may be directly adjacent to the groove. This may mean that there is no other portion of the component between the groove and the protrusion, e.g., a portion not being part of the protrusion and not of the groove. Instead, the protrusion and groove as portions of the component may be (directly) next to each other.

The groove may be a round groove. Accordingly, the groove may be at least partially rounded, e.g., having a partially circular, elliptical, or similar shape. This is particularly advantageous when casting the component such that no additional radius needs to be considered in the design of the component.

In an example, the component may comprise at least two guiding structures. Thereby, tight tolerances may be provided at both guiding structures, in particular at a space or clearance between these two, where the space or clearance may correspond in size to an outer diameter of the sleeve, e.g., substantially be equal or only slightly larger than the outer diameter of the sleeve.

In an example, two of the at least two guiding structures may be arranged in parallel to each other. The parallel guiding structures may further be arranged opposite of one another. Accordingly, the component may be guided by the sleeve via opposite and parallel protrusions of two guiding structures. The sleeve may, when guiding the component, be inserted in between the at least two guiding structures, specifically between their protrusions.

In an example, the component may comprise at least three guiding structures. This further improves the guiding by adding yet another protrusion at the guiding side.

In an example, one of the guiding structures may be arranged substantially transverse or, in other words, orthogonal to at least another one of the guiding structures. Thereby, the sleeve may be introduced between a space formed in between the three or more guiding structures arranged with respect to each other.

In an example, the component may be configured for use in a battery as the part of the vehicle. For example, the component may be a battery component of the battery. Such battery components may, for example, be or comprise a battery cell or module or be configured as a structural component for structurally supporting a battery cell or module within the battery. For example, the component may be a bracket configured for connecting individual battery cells or battery modules with one another and/or to a structural component, e.g., a battery housing. The advantage of this is that a leakage in the battery may be avoided when using the component of this disclosure as opposed to a pin and hole guiding system.

In an example, the groove and the protrusion may be forming a substantially S-shaped guiding structure. This means that the protrusion and the groove both have a rounded shape, creating a double-rounded shape, which may, in the broadest sense, be identified as an S-shape. However, the protrusion may have a much greater extension in length or protrusion direction than a depth of the groove.

According to a second aspect of this disclosure, there is provided a set comprising: a component and a sleeve. The component comprises a guiding section with at least one guiding structure located on a guiding side. The guiding structure comprises a groove extending along the guiding side and at least one protrusion directly adjacent to the groove and protruding away from the groove. The groove and the at least one protrusion are extending substantially in parallel to each other along at least a portion of the guiding side. The sleeve being configured to guide the component relative to the sleeve through the guiding section of the component when positioning the component in a part of a vehicle.

The sleeve may comprise or be made from metal, e.g., steel or aluminum.

In an example, the sleeve may comprise a cylindrical body and a hole extending inside the cylindrical body, the cylindrical body comprising an end side, the guiding section and the sleeve being configured such that the component rests with its guiding side on the end side when the component is positioned inside the part of the vehicle. By having the guiding side rest on the end side, the positioning may be facilitated.

In an example, the guiding section and the sleeve may be configured such that the at least one protrusion is outside of the hole when the component rests on the sleeve. Thereby, the at least one protrusion may, from outside of the hole and overall sleeve, guide and consequently position the sleeve at the component and vice versa.

In an example, the component may comprise at least two guiding structures, the guiding structures being spaced apart from one another such that the sleeve may be positioned in between the protrusions of the guiding structures for guiding the component relative to the sleeve.

In an example, the space between the protrusions may be substantially corresponding to an outer diameter of the sleeve. In other words, the space, in particular a clearance, between the respective protrusions may be formed substantially equal to the outer diameter of the sleeve or slightly larger than the outer diameter of the sleeve such that the sleeve may be inserted within the space substantially free of play. This may be achieved well with the tight tolerances of the component as described above and without having to provide for the tight tolerances with additional manufacturing steps, e.g., machining the component.

In an example, the sleeve may be steel, and the component may be aluminum. Specifically, the sleeve may be made from steel and the component may be made from aluminum. Thereby, the set may be kept corrosion free in the assembly of the part.

According to a third aspect of this disclosure, there is provided a vehicle comprising: a part of the vehicle and a sleeve. The part comprises at least one set, the set comprising a component. The component comprises a guiding section with at least one guiding structure located on a guiding side. The guiding structure comprising a groove extending along the guiding side and a at least one protrusion directly adjacent to the groove and protruding away from the groove. The groove and the at least one protrusion are extending substantially in parallel to each other along at least a portion of the guiding side. The sleeve configured to guide the component relative to the sleeve through the guiding section of the component when positioning the component within the part of the vehicle.

The component may further be fixed in its positioning relative to the sleeve by any fixing means inside of the part (e.g., via a screw through sleeve and component). Also, the sleeve itself may be fixed inside of the part.

It is noted that the above examples may be combined with each other irrespective of the aspects involved.

These and other aspects of the present disclosure will become apparent from and elucidated with reference to the examples described hereinafter.

### BRIEF DESCRIPTION OF DRAWINGS

Examples of the disclosure will be described in the following with reference to the following drawings.

FIG. 1 shows a perspective view of a set comprising a component and a sleeve.

FIG. 2 shows a further perspective view of the set of FIG. 1.

FIG. 3 shows a bottom view of the set of FIGS. 1 and 2.

FIG. 4 shows a side perspective view of the set of FIGS. 1 to 3.

FIG. 5 shows a further side perspective view of the set of FIGS. 1 to 4.

FIG. 6 shows a partial cross-sectional view of the set of FIGS. 1 to 5.

FIG. 7 shows a further partial cross-sectional view of the set of FIGS. 1 to 6.

FIG. 8 shows a schematic view of a vehicle having a part comprising the set of FIGS. 1 to 7.

### DETAILED DESCRIPTION

The Figures are merely schematic representations and serve only to illustrate examples of the disclosure. Identical or equivalent elements are in principle provided with the same reference signs.

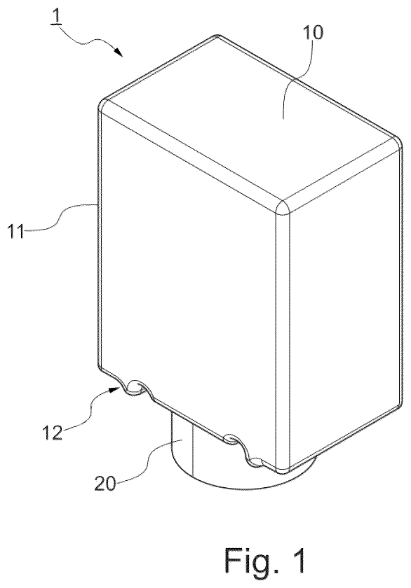

FIG. 1 shows a set 1 comprising a component 10 and a sleeve 20. Here, the component 10 and the sleeve 20 are positioned with respect to each other. In particular, the component 10 and the sleeve 20 may be assembled with one another. In general, the set 1 may have the component 10 and sleeve 20 as loose elements or positioned with respect to each other or even connected with one another, e.g., by any fixing means such as a screw.

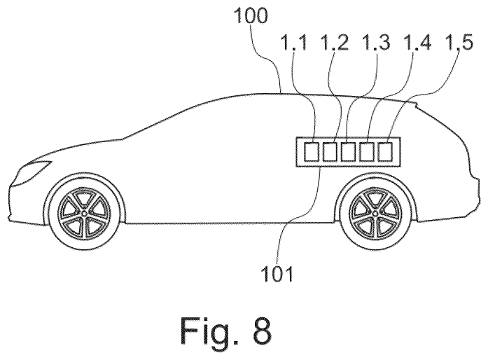

The component 10 and the sleeve 20 may be configured for use in a part 101 of a vehicle 100 (see FIG. 8), such as a battery pack, for example. In such an example, the component 10 and/or the sleeve 20 may be battery components. For example, the component 10 may be a bracket configured for connecting individual battery cells or battery modules to a structural component, e.g., a battery housing, in particular via or with assistance of the sleeve 20.

The component 10 is a casted component. Similarly, the sleeve 20 may be a casted sleeve. The component 10 has a component section 11 and a guiding section 12. The component section 11 may have one or more portions serving the function of the component, e.g., the function of a bracket. In FIG. 1, the component section 11 is simplified and shown as a block-like structure only.

The guiding section 12 is configured for guiding the component 10 relative to the sleeve 20 when positioning the component 10 inside the part 101 of the vehicle 100. In this example, the guiding section 12 is arranged at an end of the component 10. Further, the guiding section 12 is adjacent to the component section 11.

For the positioning of the component 10 in the part 101, the sleeve 20 may be already arranged in the part 101, in particular fixed therein or thereto. Therefore, the sleeve 20 may be used to guide the component 10 when positioning it inside the part 101.

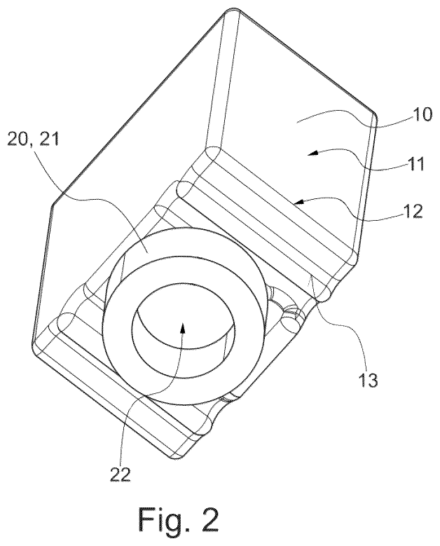

FIG. 2 shows the set 1, where the component 10 is seen in perspective from its end having the guiding section 12. The guiding section 12 is provided at a guiding side 13 of the component 10. The sleeve 20 has a cylindrical body 21 with a hole 22 extending therethrough.

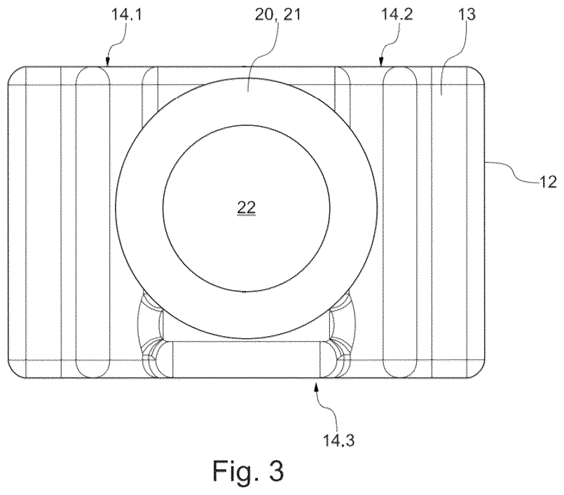

FIG. 3 also shows the set 1, where the component 10 is seen from its end having the guiding section 12 or, in other words, from its guiding side 13. As may be seen from FIG. 3, the component 10 of this example comprises three guiding structures 14.1, 14.2, 14.3. The guiding structures 14.1, 14.2 are arranged opposite of one another and, in particular, in parallel to each other. The guiding structure 14.3 is positioned between the guiding structures 14.1, 14.2 and, in particular, transverse to the other guiding structures 14.1, 14.2. Alternatively, there may be only one or two of the guiding structures 14.1, 14.2, 14.3 as described herein, e.g., only the guiding structures 14.1, 14.2.

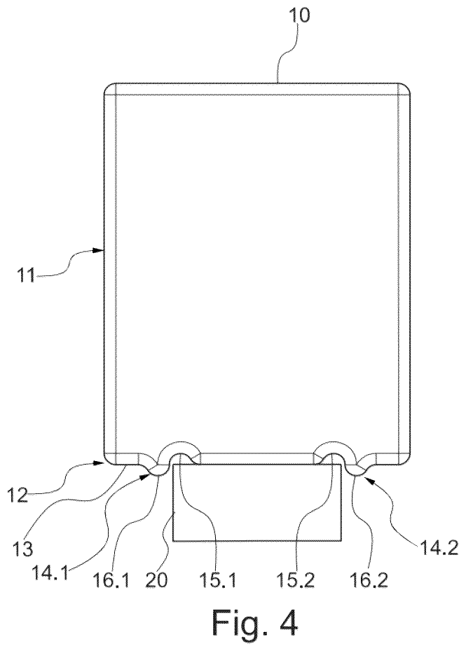

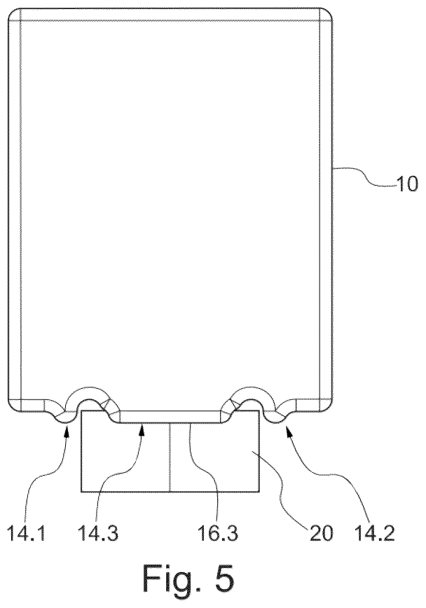

FIGS. 4 and 5 show the component 10 and the sleeve 20 in different side perspectives. The perspective of FIG. 4 is such that the two guiding structures 14.1, 14.2 may be seen, whereas the perspective of FIG. 5 is such that all three guiding structures 14.1, 14.2, 14.3 may be seen. All guiding structures 14.1, 14.2, 14.3 are arranged at the guiding side 13. And each one of the guiding structures 14.1, 14.2, 14.3 comprises a respective groove 15.1, 15.2, 15.3 (see FIG. 7 for groove 15.3), which may be rounded, and a protrusion 16.1, 16.2, 16.3 extending from the guiding side 13.

An extension or, in other words, depth of the grooves 15.1, 15.2, 15.3 into or inside the component 10 at the guiding side 13 is opposite to the extension or, in other words, protrusion of the protrusions 16.1, 16.2, 16.3. Further, the respective grooves 15.1, 15.2, 15.3 and protrusions 16.1, 16.2, 16.3 are directly adjacent to each other in each one of the guiding structures 14.1, 14.2, 14.3.

By having the grooves 15.1, 15.2, 15.3 in the component 10, the space or clearance between the protrusions 16.1, 16.2, 16.3 may be designed as close as possible to corresponding to the outer diameter of the sleeve 20 for having tight tolerances when guiding the component 10 with its guiding structures 14.1, 14.2, 14.3 relative to the sleeve 20, in particular fitting the sleeve 20 in between the protrusions 16.1, 16.2, 16.3. Without the grooves 15.1, 15.2, 15.3, the corner or edge between the protrusions 16.1, 16.2, 16.3 and the guiding side 13 would have to be provided with a radius for casting the component 10. However, such a radius requires a bigger clearance between the protrusions 16.1, 16.2, 163. The bigger clearance between the sleeve 20 and the protrusions 16.1, 16.2, 16.3 does not allow for having a positioning free of play as achieved by the grooves 15.1, 15.2, 15.3 adjacent to the protrusions 16.1, 16.2, 16.3.

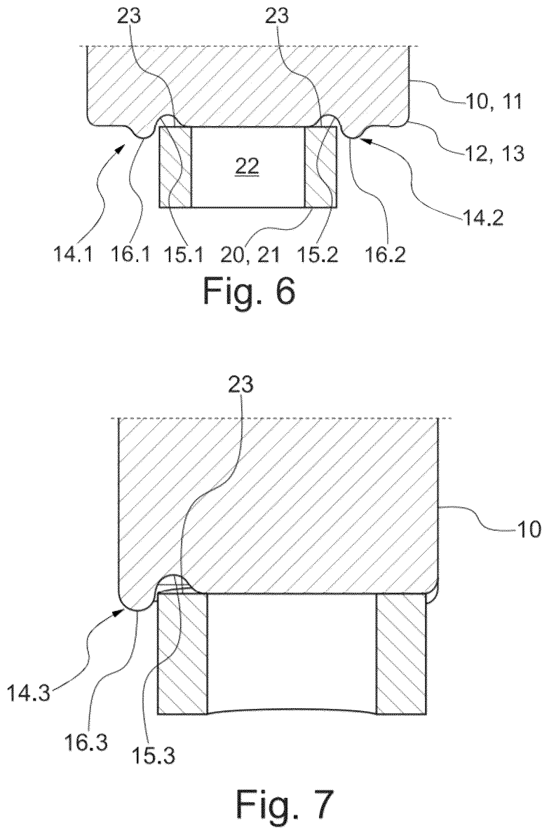

As seen in FIGS. 6 and 7, showing different cross-sectional views on a portion of the component 10 and the sleeve 20, the sleeve 20 is positioned between the protrusions 16.1, 16.2, 16.3. For illustrative purposes, a clearance between the protrusions 16.1, 16.2, 16.3 and the sleeve 20 may be larger than required. The component 10 rests with its guiding side 13 on the end side 23 of the sleeve 20.

FIG. 8 shows a vehicle 100 having the part 101, in which several sets 1.1, 1.2, 1.3, 1.4, 1.5 as described above are being used. The part 101 may be a battery of the vehicle 100, for example. And the components 10 of each one of the sets 1.1, 1.2, 1.3, 1.4, 1.5 may be battery components or battery-related components, e.g., brackets for holding battery cells or modules of the battery.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one example, to at least one, optionally including more than one, A, with no B present (and optionally including entities other than B); in another example, to at least one, optionally including more than one, B, with no A present (and optionally including entities other than A); in yet another example, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

Other variations to the disclosed examples can be understood and effected by those skilled in the art in practicing the claimed disclosure, from the study of the drawings, the disclosure, and the appended claims. In the claims the word “comprising” does not exclude other elements or steps and the indefinite article “a” or “an” does not exclude a plurality. Any reference signs in the claims should not be construed as limiting the scope of the claims.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc. in question is or is not removable.

As used herein, the term “or” means an inclusive “or” rather than an exclusive “or.” That is, unless specified otherwise, or clear from context, “X uses A or B” means any of the natural inclusive permutations. That is, if X uses A; X uses B; or X uses both A and B, then “X uses A or B” is satisfied under any of the foregoing instances.

As used herein, two or more elements are “integral” if they comprise the same piece of material or if they operate functionally together. Two or more elements are “non-integral” if each comprises a different piece of material or if each element can operate functionally independently.

As used herein the term “component” refers to a distinct and identifiable part, element, subsystem, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software and/or other engineering elements.

The term “vehicle” as used herein refers to a thing used for transporting people or goods. Automobiles, cars, trucks, buses etc. are examples of vehicles.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

### LIST OF REFERENCE SIGNS

1 set
10 component
11 component section
12 guiding section
13 guiding side
14 guiding structure
15 groove
16 protrusion
20 sleeve
21 cylindrical body
22 hole
23 end side
100 vehicle
101 part

What is claimed is:

1. A component comprising:
a guiding section configured to guide the component relative to a sleeve when positioning the component inside a part of a vehicle, wherein the guiding section comprises at least one guiding structure located on a guiding side of the component, the at least one guiding structure comprises a groove extending at the guiding side and at least one protrusion directly adjacent to the groove and protruding away from the groove, the groove and the at least one protrusion are extending substantially in parallel to each other along at least a portion of the guiding side.

2. The component of claim 1, further comprising at least two guiding structures.

3. The component of claim 2, wherein two of the at least two guiding structures are positioned in parallel to each other.

4. The component of claim 1, further comprising at least three guiding structures.

5. The component of claim 4, wherein one of the at least three guiding structures is positioned substantially transverse to at least another one of the guiding structures.

6. The component of claim 1, wherein the component is configured for use within a battery as the part of the vehicle.

7. The component of claim 1, wherein the groove and the at least one protrusion form a substantially S-shaped guiding structure.

8. A set comprising:
a component, wherein the component comprises a guiding section with at least one guiding structure located on a guiding side, the guiding structure comprises a groove extending along the guiding side and at least one protrusion directly adjacent to the groove and protruding away from the groove, the groove and the at least one protrusion are extending substantially in parallel to each other along at least a portion of the guiding side; and
a sleeve, the sleeve being configured to guide the component relative to the sleeve through the guiding section of the component when positioning the component in a part of a vehicle.

9. The set of claim 8, wherein the sleeve comprises a cylindrical body and a hole extending inside the cylindrical body, wherein the cylindrical body comprising an end side, the guiding section and the sleeve are configured such that the component rests with the guiding side on the end side when the component is positioned inside the part of the vehicle.

10. The set of claim 9, wherein the guiding section and the sleeve are configured such that the at least one protrusion remains outside of the hole when the component rests on the sleeve.

11. The set of claim 8, wherein the component comprises at least two guiding structures, the at least two guiding structures being spaced apart from one another such that the sleeve is positioned in between the at least one protrusion of the at least two guiding structures for guiding the component relative to the sleeve.

12. The set of claim 11, wherein the space between the at least one protrusion substantially corresponds to an outer diameter of the sleeve.

13. The set of claim 8, wherein the sleeve comprises steel.

14. The set of claim 8, wherein the component comprises aluminum.

15. A vehicle (100) comprising:
a part of the vehicle, wherein the part comprises at least one set, the set comprising a component, wherein the component comprises a guiding section with at least one guiding structure located on a guiding side, the guiding structure comprising a groove running along the guiding side and a at least one protrusion directly adjacent to the groove and protruding away from the groove, the groove and the at least one protrusion are extending substantially in parallel to each other along at least a portion of the guiding side; and
a sleeve is configured to guide the component relative to the sleeve through the guiding section of the component when positioning the component within the part of the vehicle.

16. The vehicle of claim 15, wherein the sleeve comprises steel.

17. The vehicle of claim 15, wherein the component comprises aluminum.

18. The vehicle of claim 15, wherein the sleeve comprises a cylindrical body and a hole extending inside the cylindrical body, wherein the cylindrical body comprises an end side, the guiding section and the sleeve are configured such that the component rests with the guiding side on the end side when the component is positioned inside the part of the vehicle.
